(19) United States
(12) Patent Application Publication
(10) Pub. No.: US 2011/0057910 A1
(43) Pub. Date: Mar. 10, 2011

(54) DRIVING DISPLAYS

(75) Inventors: Christopher James Newton FRYER, Cambridge (GB); Richard Guy BLAKESLEY, Cambridge (GB)

(73) Assignee: MFLEX UK LIMITED, Cambridge (GB)

(21) Appl. No.: 12/879,082

(22) Filed: Sep. 10, 2010

Related U.S. Application Data
(63) Continuation of application No. PCT/GB2009/000685, filed on Mar. 6, 2009.

(30) Foreign Application Priority Data
Mar. 15, 2008 (GB) 0804876.1
Mar. 28, 2008 (GB) 0805606.1

(51) Int. Cl. G06F 3/038; G09G 3/30

(52) U.S. Cl. 345/208; 345/76

(57) ABSTRACT

A method of driving a display, wherein the display comprises a layer of electroluminescent material (EL) and a layer of physically-stabilised liquid crystal (LC) wherein the layers of EL and LC are powered by a common set of electrodes. The method comprises driving the common electrodes with a voltage waveform which is substantially a truncated triangular waveform.

### BACKGROUND OF THE INVENTION

1. Field of the Invention

This invention relates to a method of driving a display, together with drive circuitry for implementing the method. In particular, the invention relates to a method of driving a display comprising a layer of electroluminescent material (EL) and a layer of physically-stabilised Liquid Crystal (LC) together with a drive circuit for such a display.

2. Description of the Related Art

FIG. 1 of the accompanying drawings shows a display which is suitable for being driven by preferred embodiments of the invention. The display comprises, from front to back: a relatively thick protective electrically-insulating transparent front layer (11; the substrate); over the rear face of the substrate 11, a relatively thin transparent electrically-conductive film (12) forming the front electrode of the display; covering the rear face of the front electrode 12, a relatively thin layer (13) of LC material (14) physically-stabilised by being dispersed within a supporting matrix (15); formed directly on, and covering the rear face of, the liquid crystal layer 13, a relatively thin layer (16) of electroluminescent/phosphor material (17) dispersed within a supporting matrix (18); over the rear face of the phosphor layer 16, a relatively thin optically-reflective electrically-insulating layer (19) of a relatively high dielectric constant material (in the Figure this layer is shown as a seamless extension of the phosphor layer 16); and disposed over the rear face of the reflective electrically-insulating layer 19, an electrically-conductive film (20) forming the rear electrode(s) of the display.

The front and rear electrodes together define which areas of both the liquid crystal layer and the electroluminescent layer can be selected to be switched “on” or “off”.

In addition, the back electrode layer may be covered with a protective film (not shown here).

In an alternative preferred embodiment of the display shown in FIG. 2 of the accompanying drawings, the EL and LC materials are not directly formed on one another, but are instead separated by an insulating interlayer 10. In all other aspects, the preferred embodiments are the same and common reference numerals have been used.

In either case with or without the interlayer 10, the EL and LC materials can share the common pair of electrodes 12, for common activation of the EL and LC materials. This can be used to generate a display of selectively illuminatable indicia as show schematically in FIG. 3 of the accompanying drawings. This shows how a common front electrode 12 and substrate can support multiple indicia 21a, 21b. Each indicium 21a, 21b comprises the remaining layers of the structure shown in FIG. 1 or FIG. 2 or the accompanying drawings, namely the LC layer 13, optionally the interlayer 10, the EL layer 17, the reflective insulating layer 18 and the rear electrode 20. These layers are shaped to provide selectively illuminatable elements that can be illuminated to provide indications to a user; in the present example these are the numbers “5” and “6” but could be extended to any indicia.

Thus, a display as described in relation to FIGS. 1 to 3 comprises both a layer of electroluminescent material (EL) and a layer of physically-stabilised Liquid Crystal (LC).

In the field of EL displays, it is known that the drive waveform is a compromise between many factors which try to maximise display brightness while minimising noise. In such a display, the brightness is a function of the peak value of the voltage of the applied waveform, and the noise is a function of the harmonic components of the applied waveform. To minimise the noise of the display whist maintaining brightness, it is practised in the art to apply an approximation to a sine wave. A true sine wave would be ideal but this is difficult to implement in practice.

However, the display shown in FIGS. 1 and 2 is a combination of EL and LC displays and as such the optimal waveform for driving an EL display is not necessarily the optimal waveform for driving a display having both EL and LC layers.

### SUMMARY OF THE INVENTION

According to a first aspect of the invention there is provided a method of driving a display, wherein the display comprises a layer of electroluminescent material (EL) and a layer of physically-stabilised Liquid Crystal (LC) wherein the layers of EL and the LC are powered by a common set of electrodes, and wherein the method comprises driving the common electrodes with a voltage waveform which is substantially a truncated triangular waveform.

Such a method has been found to be efficient at driving a display which comprises both the EL and LC layers. It is believed that the whilst the EL layer responds in terms of light output being a function of the peak waveform applied, the performance of the LC layer is a function of the RMS field applied thereto.

Conveniently, the truncated triangular waveform comprises a region in which the voltage rises relatively rapidly. It is advantageous if, in this region, the waveform can rise as fast as possible, but not so fast that it contains high frequencies which would cause excessive noise in the display.

In some preferred embodiments, the rise time is in the range of roughly 100 μs to 500 μs. In other preferred embodiments, the rise time is in the range of roughly 175 μs to roughly 425 μs. In another preferred embodiment, the rise time is roughly 250 μs. These rise times are examples for a waveform having a fundamental frequency of in the range of roughly 50 Hz to IkHz. The skilled person will appreciate that the as the fundamental frequency increases then the rise time of the waveform will decrease.

Further, the truncated triangular waveform generally comprises a region of substantially constant voltage. Such a region is advantageous as it increases the RMS voltage of the applied waveform.

Further, the truncated triangular waveform generally comprises a region in which the voltage is reduced to substantially zero.

As such, the truncated triangular waveform may be thought of as a waveform having three separate portions: a first portion in which the voltage is increased from substantially zero to a predetermined voltage; a second portion in which the voltage of the waveform is held substantially at the predetermined voltage; and a third portion in which the voltage of the waveform is reduced from the predetermined voltage to substantially zero volts.

Generally, the waveform is an AC waveform. Generally, the negative going portion of the waveform is substantially a mirror image of the positive going portion of the waveform.

The method may include using a Boost converter to generate the waveform, the Boost converter including an inductor and a switch.

In the first portion of the waveform, the method may comprise switching the switch at a first rate in order to increase the voltage.

In a typical preferred embodiment, the switch, in the first portion, is switched at a frequency in the range of 50 kHz to 200 kHz. In other preferred embodiments, the switch is switched in the range of roughly 75 kHz to 175 kHz. In another preferred embodiment, the switch is switched at roughly 100 kHz. The skilled person will appreciate that the frequency at which the switch is switched is will dependent upon the input voltage and the size of the inductor together with the voltage to which it is desired to increase the voltage.

In the second portion of the waveform the method may comprise monitoring the voltage of the waveform and switching the switch, in order to increase the voltage, if voltage falls below the predetermined threshold.

According to a second aspect of the invention there is provided a display driver, arranged to drive a display comprising a layer of electroluminescent material (EL) adjacent a layer of physically stabilised Liquid Crystal (LC) wherein the EL layer and the LC layer are powered by a common set of electrodes, wherein the display driver comprises a voltage generator arranged to apply a varying voltage across the common set of electrodes, wherein the voltage generator is arranged to generate a substantially truncated triangular waveform.

Conveniently, the voltage generator comprises a Boost converter including an inductor and a switch.

The display driver may also comprise control circuitry arranged to control the Boost converter.

The truncated triangular waveform may be thought of as a waveform having three separate portions: a first portion in which the voltage is increased from substantially zero to a predetermined voltage; a second portion in which the voltage of the waveform is held substantially at the predetermined voltage; and a third portion in which the voltage of the waveform is reduced from the predetermined voltage to substantially zero volts.

The control circuitry may be arranged to switch the switch at a first rate during the first portion of the waveform.

The control circuitry may be arranged, in a second portion of the waveform, to monitor the voltage of the waveform and switch the switch, in order to increase the voltage, if voltage falls below the predetermined voltage.

In a third portion of the waveform, the control circuitry may be arranged to open a discharge path in order to discharge charge accumulated on a display connected to the driver with said discharge conveniently being at a controlled rate. Such a path is convenient as it can help to rapidly allow the display to be recharged in the subsequent cycle of the waveform.

According to a third aspect of the invention there is provided a display comprising a layer of electroluminescent material (EL) adjacent a layer of physically stabilised Liquid Crystal (LC) wherein the EL layer and the LC layer are powered by a common set of electrodes, and a voltage generator arranged to apply a varying voltage across the common set of electrodes, wherein the voltage generator is arranged to generate a substantially truncated triangular waveform.

The display may include any of the features described in relation to the display driver of the second aspect of the invention.

According to a fourth aspect of the invention there is provided a machine readable medium containing instructions which when read onto a display driver cause that display driver to function as the display driver of the second aspect of the invention.

The machine readable medium referred to herein may be any of the following: a floppy disk, a CD-ROM/RAM, a DVD ROM/RAM (including −R/+R or −RW/+RW), a Blu Ray disc, an HD DVD ROM, a tape, a hard drive, a memory (including a USM memory stick, a memory card, etc.), a signal (including an Internet download, an FTP transfer, etc), a wire, or any other suitable medium.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 (Prior Art) schematically shows a cross section through a first preferred embodiment of a display suitable for being driven by a preferred embodiment of the invention;

FIG. 2 (Prior Art) schematically shows a cross section through a second preferred embodiment of a display suitable for being driven by a preferred embodiment of the invention;

FIG. 3 (Prior Art) schematically shows a plan view of a display as shown in either of FIG. 1 or 2;

FIG. 4 schematically shows a waveform according to a preferred embodiment of the invention;

FIG. 5 schematically shows a waveform used to generate the waveform of FIG. 4;

FIG. 6 shows an oscilloscope trace of a waveform substantially according to the waveform shown in FIG. 4; and

FIG. 7 shows an example of a circuit suitable for producing the waveform shown in FIG. 4.

### DETAILED DESCRIPTION OF THE PREFERRED EMBODIMENTS

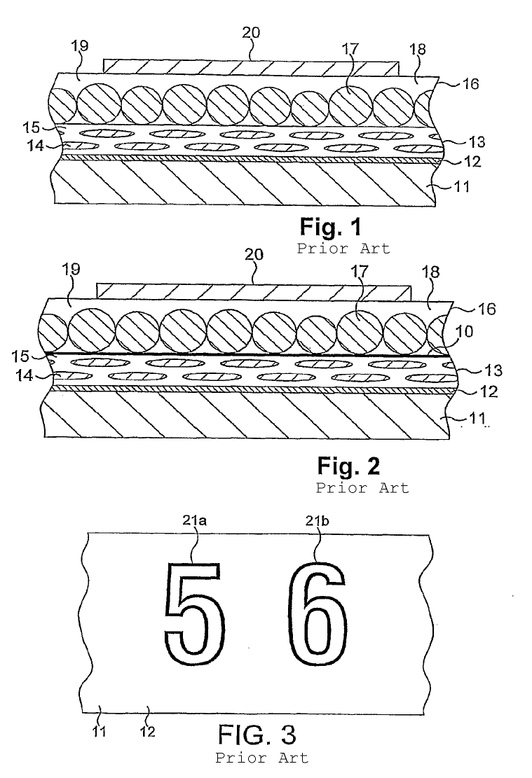

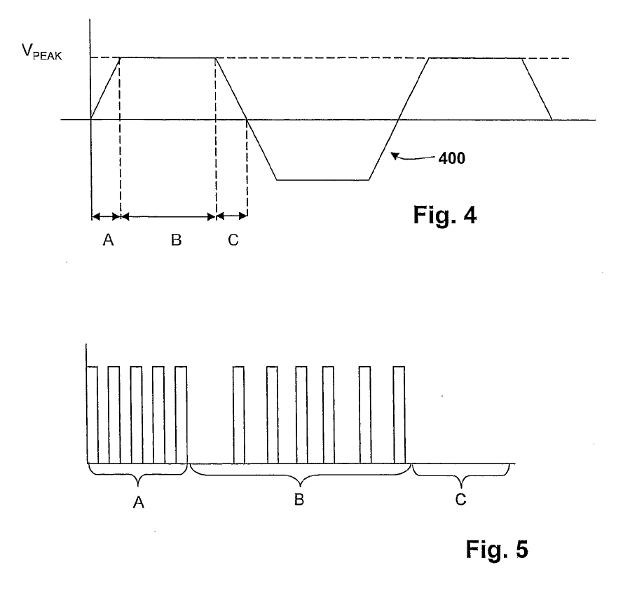

FIGS. 1 to 3 have been described above and will not be described again here.

FIG. 4 shows a waveform 400 which is suitable for driving the displays shown in Figure. The waveform is substantially a truncated triangular waveform which comprises a first portion (A), a second portion (B) and a third portion (C).

In the first portion (A) the voltage of the waveform increases substantially from substantially zero volts to a predetermined voltage V_{PEAK}. In the second portion (B) the voltage of the waveform is held at substantially the predetermined voltage V_{PEAK}. In the third portion (C) the voltage decreases from the predetermined voltage to substantially zero volts. It will then be seen that the waveform repeats but as a negative voltage.

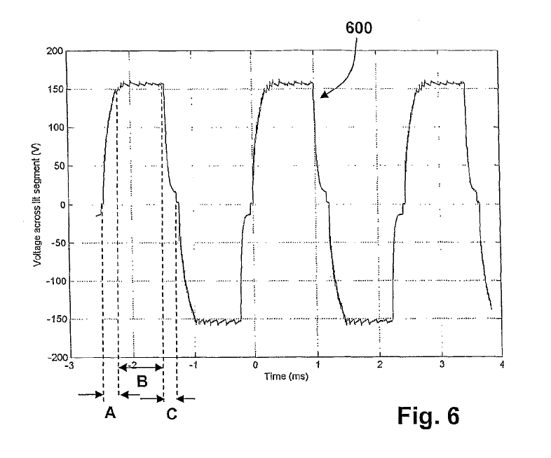

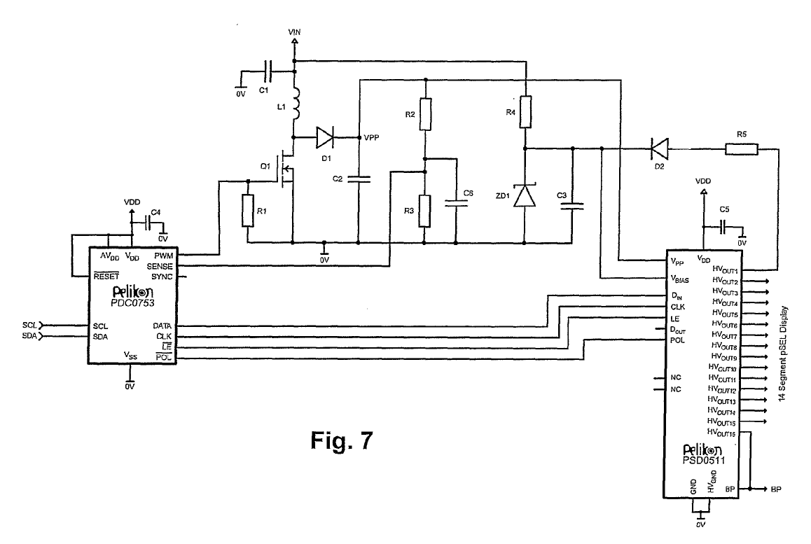

FIG. 6 shows a waveform 600 generated by the circuit of FIG. 7. It can be seen that the waveform 600 comprises the three portions A, B and C which are discussed in relation to FIG. 4.

Referring now to FIG. 7, it can be seen that the circuitry comprises a Boost converter provided by the inductor L1, the switch Q1 and the diode D1. These three components provide what may be thought of as a voltage generator.

Switching of the switch Q1 is controlled by control circuitry, which in this preferred embodiment is provided by the PDC0753 integrated circuit. An output pin of the PDC0753, labelled PWM (Pulse Width Modulated), is connected to the gate of transistor which provides the switch Q1. Thus, a high pulse on the PWM output allows current to pass through the inductor L1 since the transistor Q1 is can then pass current therethrough.

The cathode of the diode D1 is connected to a capacitor C2 which, as is described hereinafter, accumulates charge as the switch Q1 is switched. The cathode of the diode D1 (and therefore also the capacitor C2) is connected to the V_{PP} input of the integrated circuit PSD0511. This second integrated circuit uses the voltage applied to the Vₚₚ pin to drive a display connected to the HV_{00T} pins.

In use, a high pulse is applied to the gate of the transistor Q1 and current flows through the inductor L1 to ground. This current ramps up linearly at a rate proportional to the input voltage divided by the inductance. The energy stored in the inductor is equal to one-half the inductance times the square of the peak current. An input capacitor C1 filters the V_{1N} supply voltage to improve circuit efficiency and avoid current peaks on the V_{IN} supply.

When the PWM output goes low, the transistor Q1 turns off, but the inductor current does not change instantly so the voltage at a switching node (between L1, Q1 and D11) rises to whatever is required to maintain current flow. The diode D1 then becomes forward biased and the energy that was stored in the inductor L1 becomes transferred to charge stored in the capacitor C2.

After the energy has been transferred to capacitor C2, the diode is reversed biased and prevents the capacitor C2 from discharging again through the transistor Q1 to ground or through the inductor L1 to the Y_{1N} supply.

This process is repeated, with the PWM output pulsing on and off to make the voltage on the capacitor C2 rise in steps to generate the required, predetermined, voltage V_{PP} which is used to drive a display connected to the second integrated circuit.

The V_{PP} voltage is measured by feedback resistors R2 and R3 which divide the V_{PP} voltage by a factor of 100. The skilled person will appreciate that V_{PP} will be on the order of several hundred volts and as such needs reducing before it can be measured by the SENSE input of the Integrated Circuit PDC0753. A capacitor C6 is used to filter out spikes on Vpp to enable accurate measurement.

This process of applying a high/low pulse to the gate of transistor Q1 occurs during the first period A of the waveform as can be seen in

FIG. 5 in which the vertical axis shows the voltage of the gate of transistor Q1. Thus, during period A a regular pulse is applied to the gate of transistor Q1. In the preferred embodiment being described this is at a frequency of roughly 100 kHz.

During the hold phase, i.e. during portion B of the waveform, the voltage of Vₚₚ is measured using the sense input of the PDC0753 integrated circuit. As V_{PP} falls below the predetermined voltage then the PWM output is caused to apply a high pulse to the gate of transistor Q1. The voltage of V_{PP} is expected to fall due to the load of the feedback resistors R2 and R3.

This causes more charge to be added to the capacitor C2, in the manner described above, which increases the voltage of V_{PP}. Thus, looking at FIG. 5 it will be seen that, during portion B of the waveform, irregular pulses are applied to the gate of transistor Q1. It should be noted that the horizontal scale of FIGS. 4 and 5 are different.

Also, looking at the trace shown in FIG. 6, ripples in the voltage can be observed, as the transistor Q1 is turned on and off.

Once a predetermined portion B of the waveform has elapsed which in this preferred embodiment is roughly 750 us. the Hvout1 output from the PSD0511 is set high, i.e. connected to VPP to create a discharge path for charge accumulated on a display driven by the circuit. This causes diode D2 to become forward-biased, and current flows through resistor R5 into capacitor C3. This discharges the VPP voltage from the display segments (which are connected to the HVout 2-15 pins) and from the capacitor C2. The voltage on capacitor C3 is limited to 6.2V by the zener diode ZD1 and therefore, after C3 has been charged up to 6.2V, the discharge current will be diverted through the zener diode ZD1.

In other preferred embodiments, the period B may be in the range of roughly 500 μs to 1 ms. In other preferred embodiments, the period B may be in the range of roughly 625 μs to roughly 875 μs.

Thus, it will be seen from the above description and by looking at FIG. 5 that the third portion of the waveform comprises a discharge curve and is therefore exponential in nature. The rate at which the discharge occurs is governed by the magnitude of the resistor R5.

In the preferred embodiment being described the period C is roughly 200 μS. However, in other preferred embodiments, the period C may be in the range of roughly 50 μs to 350 μs. In other preferred embodiments, the period C may be in the range of roughly 125 μs to 325 μs.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of driving a display comprising an electroluminescent material layer, a physically-stabilized liquid crystal layer, and common electrodes arranged to drive the electroluminescent material layer and the liquid crystal layer, the method comprising the step of driving the common electrodes with a voltage waveform which is a truncated triangular waveform or a substantially truncated triangular waveform.

2. A method according to claim 1, wherein the truncated triangular waveform has a period T and includes a region in which the voltage rises from zero to a maximum value in a range of about 0.02×T to about 0.15×T.

3. A method according to claim 1, wherein the voltage waveform includes a region of constant or substantially constant voltage.

4. A method according to claim 1, wherein the voltage waveform includes a region in which the voltage is zero or substantially zero.

5. A method according to claim 1, wherein the voltage waveform is an AC waveform.

6. A method according to claim 5, wherein a negative portion of the voltage waveform is a mirror image or is substantially a mirror image of a positive portion of the voltage waveform.

7. A method according to claim 1, further comprising the step of using a boost converter to generate the voltage waveform; wherein
the boost converter includes a switch.

8. A method according to claim 7, further comprising the step of, during a first portion of the voltage waveform, switching the switch at a first rate to increase the voltage.

9. A method according to claim 8, further comprising the steps of, during a second portion of the voltage waveform:
monitoring a voltage of the voltage waveform; and
switching the switch to increase the voltage if the voltage falls below a predetermined threshold.

10. A display driver arranged to drive a display including an electroluminescent material layer, a physically-stabilized liquid crystal layer adjacent to the electroluminescent material layer, and common electrodes arranged to drive the electroluminescent material layer and the liquid crystal layer, the display driver comprising:
a voltage generator arranged to apply a voltage waveform across the common electrodes; wherein
the voltage waveform is a truncated triangular waveform or a substantially truncated triangular waveform.

11. A driver according to claim 10, wherein the voltage generator includes a boost converter including a switch.

12. A driver according to claim 11, further comprising control circuitry arranged to control the boost converter.

13. A driver according to claim 12, wherein the control circuitry is arranged to switch the switch at a first rate during a first portion of the voltage waveform in which a voltage of the voltage waveform rises such that the voltage waveform does not include frequencies that cause noise in the display.

14. A driver according to claim 13, wherein the control circuitry is arranged to, during a second portion of the voltage waveform in which the voltage of the voltage waveform is constant or substantially constant at a predetermined voltage:
monitor the voltage of the waveform; and
switch the switch to increase the voltage if the voltage falls below the predetermined voltage.

15. A driver according to claim 14, wherein, during a third portion of the voltage waveform in which the voltage of the voltage waveform is reduced from the predetermined voltage, the control circuitry is arranged to open a discharge path to discharge a charge accumulated on the display connected to the driver.

16. A display comprising:
an electroluminescent material layer;
a physically-stabilized liquid crystal;
common electrodes; and
a voltage generator arranged to apply a voltage waveform across the common electrodes; wherein
the voltage generator is arranged to generate a truncated triangular waveform or a substantially truncated triangular waveform.

17. A tangible machine-readable medium including instructions which when read by a display driver cause the display driver to function as the display driver of claim 10.

18. A tangible machine-readable medium including instructions which when read by a circuit cause the circuit to perform the method of claim 1.
